(19) United States
(12) Patent Application Publication
(10) Pub. No.: US 2020/0273452 A1
(43) Pub. Date: Aug. 27, 2020

(54) METHOD AND DEVICE FOR ANALYZING AND DISTRIBUTING VOICE COMMANDS

(71) Applicant: DELTA DORE, Bonnemain (FR)

(72) Inventor: Jean LE TUTOUR, Bonnemain (FR)

(21) Appl. No.: 16/062,819

(22) PCT Filed: Dec. 13, 2016
(86) PCT No.: PCT/EP2016/080840

§ 371 Date: Jun. 15, 2018

(30) Foreign Application Priority Data
Dec. 17, 2015 (FR) 1562618

(51) Int. Cl. G10L 15/22; G10L 15/26

(52) U.S. Cl. CPC G10L 15/22; G10L 2015/223; G10L 15/26

(57) ABSTRACT

The invention relates to a method and to a device for analyzing and distributing voice commands transmitted by an individual seeking to control a peripheral unit from among a plurality of peripheral units contained in a building. At least one peripheral unit is managed by an application management device different from at least one other application management device managing at least one other peripheral unit, wherein:
lists of words and/or groups of words are received that can be interpreted by the application management devices;
the lists are stored (E407);
the reception of a voice command is detected (E400);
the voice command is analyzed (E401) and the corresponding management device is identified (E402);
the command is transcribed (E404) and transferred (E405) to an application management device.

The present invention relates to a method and to a device for analyzing and distributing voice commands transmitted by an individual seeking to control a peripheral unit.

For many people, voice command of domestic appliances is the optimal way of managing the operation of the various items of equipment in a dwelling.

The ability to voice command peripheral units such as blackout devices, lighting, household appliances or an ambient temperature makes life easier for the residents of a dwelling.

In order for a peripheral unit to be able to interpret a voice command, the peripheral unit must have voice processing and recognition means, which cannot be contemplated for the simple reason that the cost of the peripheral unit would be significantly increased.

Another solution would involve using a centralized device that performs processing, voice recognition of voice commands and controls the relevant peripheral units. This solution is complex to implement as the peripheral units are manufactured by various manufacturers, quite often using proprietary protocols for controlling the peripheral units that they manufacture. Furthermore, the problem of updating the centralized device is raised when a new peripheral unit is installed in the dwelling.

The aim of the present invention is to overcome the disadvantages of the prior art by proposing a method and a device for analyzing and distributing voice commands transmitted by an individual seeking to control a peripheral unit from a plurality of peripheral units contained in a building, which method and device are simple to implement and can be easily updated when a new peripheral unit is installed in the dwelling.

To this end, according to a first aspect, the invention proposes a method for analyzing and distributing voice commands transmitted by an individual seeking to control a peripheral unit from among a plurality of peripheral units contained in a building, characterized in that at least one peripheral unit is managed by an application management device different from at least one other application management device managing at least one other peripheral unit, the method comprising the following steps, executed by a device for analyzing and distributing voice commands:

receiving, from each application management device, a list of words and/or groups of words that can be interpreted by the application management device;

storing each list of words and/or groups of words in combination with an identifier of the application management device that transferred the list of words and/or groups of words;

detecting the reception of a voice command;

analyzing the voice command by identifying a word or group of words included in the voice command and belonging to a list of words or group of words stored in the device for analyzing and distributing voice commands;

identifying the application management device associated with the list comprising a set of words and/or groups of words in which the word or the group of words included in the voice command is included;

transcribing the voice command into a vocabulary that can be interpreted by the application management device;

transferring the transcribed voice command to the application management device.

The present invention further relates to a device for analyzing and distributing voice commands transmitted by an individual seeking to control a peripheral unit from among a plurality of peripheral units contained in the building, characterized in that at least one peripheral unit is managed by an application management device different from at least one other application management device managing at least one other peripheral unit, the device comprising:

means for receiving, from each application management device, a list of words and/or groups of words that can be interpreted by the application management device;

means for storing each list of words and/or groups of words in combination with an identifier of the application management device that transferred the list of words and/or groups of words;

means for detecting the reception of a voice command;

means for analyzing the voice command by identifying a word or group of words included in the voice command and belonging to a list of words or group of words stored in the device for analyzing and distributing voice commands;

means for identifying the application management device associated with the list comprising a set of words and/or groups of words in which the word or the group of words included in the voice command is included;

means for transcribing the voice command into a vocabulary that can be interpreted by the application management device;

means for transferring the transcribed voice command to the application management device.

Thus, by using a device for analyzing and distributing voice commands and a plurality of application management devices, it is possible to economically control various types of peripheral units. For example, each application management device is designed and updated by each peripheral unit manufacturer and allows the manufacturer to use proprietary communication protocols between its peripheral units and its application management device. Updates are also significantly simplified.

Furthermore, as the device for analyzing and distributing voice commands knows the words or groups of words that it will likely have to analyze, the voice recognition performed by the device for analyzing and distributing voice commands is optimized.

According to a particular embodiment of the invention, the device for analyzing and distributing voice commands:

receives a message comprising at least one word and/or at least one group of words from an application management device;

deletes the at least one word and/or the at least one group of words from the list of words or groups of words associated with the identifier of the application management device that transferred the at least one word and/or the at least one group of words.

Thus, the device for analyzing and distributing voice commands is adapted to the various application management devices and sends them the various commands in an optimal manner.

Furthermore, the device for analyzing and distributing voice commands does not need to be updated in order to be adapted to new application management devices.

According to a particular embodiment of the invention, the transcription of the voice command is in the form of text or of symbols representing words.

Thus, the voice recognition analysis, which is analysis power intensive, is centralized and specific to the building. A symbols transcription allows multilingual operation, with the same symbol being able to be used for the same word in various languages.

According to a particular embodiment of the invention, each application management device:

receives a transcribed voice command;

identifies the peripheral unit capable of processing the transcribed voice command;

transfers a control message to the peripheral unit.

Thus, the performance of each application management device is specific and its operation can be best adapted for the peripheral units that it controls, independently of the other application management devices.

According to a particular embodiment of the invention, if an application management device cannot identify a peripheral unit or process the transcribed voice command, the application manager transfers a message comprising a report of the non-execution of the received transcribed voice command, as well as a possible list of at least one word and/or of at least one group of words associated with the received transcribed voice command.

Thus, the device for analyzing and distributing voice commands can best optimize the information transmitted to the various application management devices, taking into account the reports of non-executions of received transcribed voice commands, as well as any lists of at least one word and/or of at least one group of words associated with the transcribed voice commands.

The invention also relates to computer programs stored on a data medium, said programs comprising instructions allowing the aforementioned methods to be implemented, when they are loaded and executed by a computer system.

The aforementioned features of the invention, as well as other features, will become more clearly apparent upon reading the following description of an embodiment, said description being provided with reference to the accompanying drawings, in which:

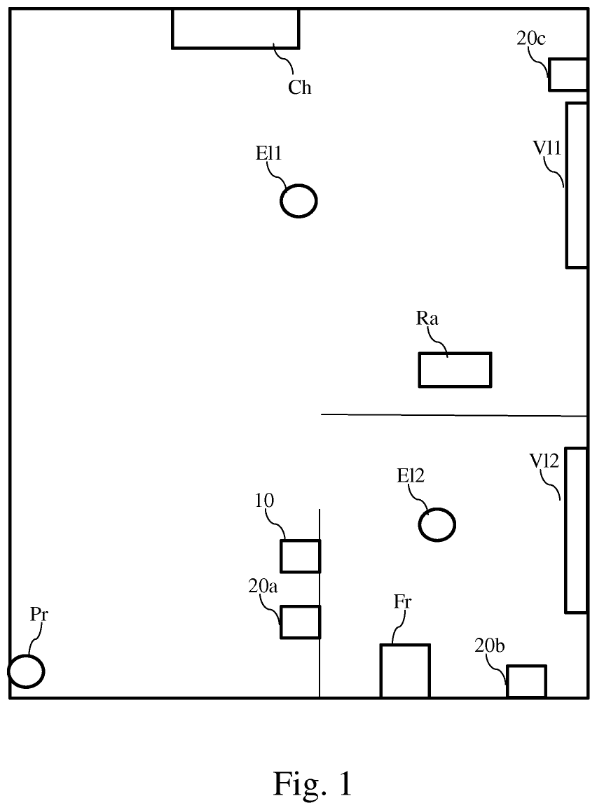

FIG. 1 shows an example of a voice command system for peripheral units managed by various applications in a building in which the present invention is implemented;

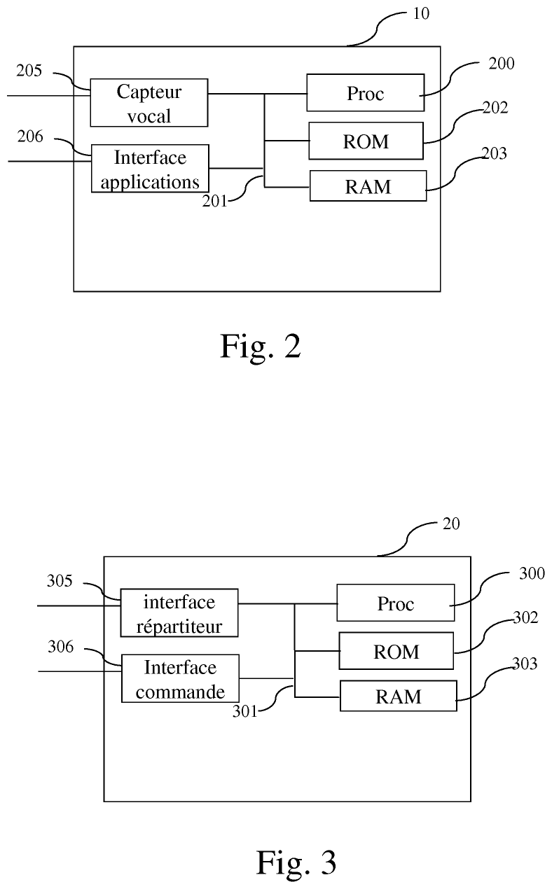

FIG. 2 shows an example of an architecture of a voice command analyzer-distributor device according to the present invention;

FIG. 3 shows an example of an architecture of an application management device according to the present invention;

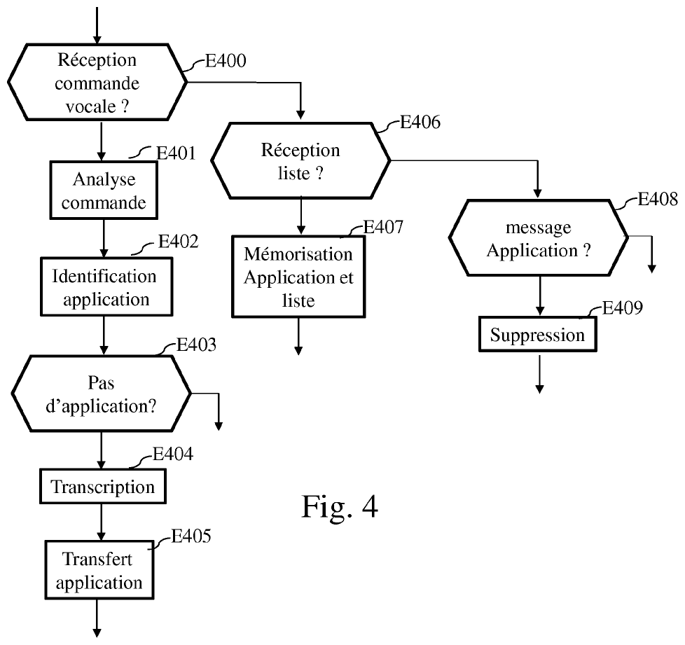

FIG. 4 shows an example of an algorithm executed by a voice command analyzer-distributor device according to the present invention;

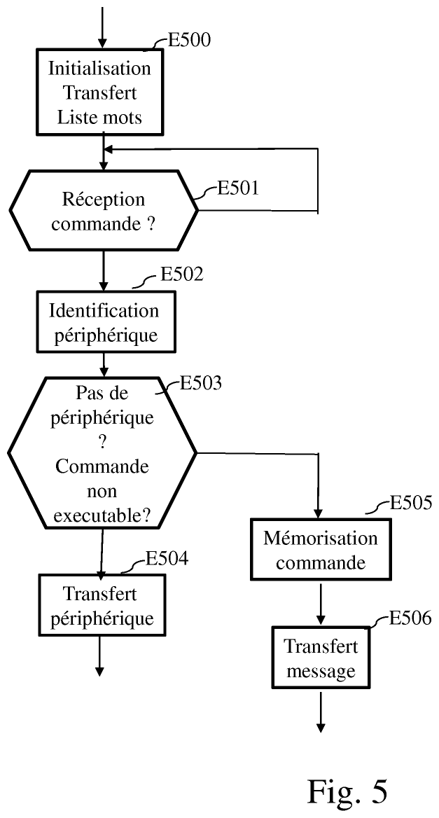

FIG. 5 shows an example of an algorithm executed by an application management device according to the present invention.

FIG. 1 shows an example of a voice command system for peripheral units managed by various application management devices in a building in which the present invention is implemented.

The system comprises a voice command analyzer-distributor device 10 and a plurality of application management devices 20a, 20b and 20c.

The voice command analyzer-distributor device 10 is capable of receiving a voice command from an individual seeking to control a peripheral unit contained in the building, of identifying, on the basis of an analysis of the voice command, the application management device managing the peripheral unit, of transcribing the voice command into a vocabulary that can be interpreted by the application management device managing the peripheral unit and of transferring a message comprising the transcription of the voice command to the application management device managing the peripheral unit.

The transcription of the command is in the form of text or of symbols representing a word, for example.

The application management device 20 managing the peripheral unit processes the transcription of the voice command included in the message, determines whether the command corresponds to a peripheral unit that it manages and, if so, transfers a control message to the peripheral unit that can be interpreted by the peripheral unit.

In the example of FIG. 1, the application management device 20a is a device that is capable, for example, of controlling the turning on, the variation of intensity, the turning off of lighting devices E11, E12, the full or partial opening, the closing of blackout devices V11, V12, such as roller shutters, the modification of an ambient temperature from a heating system, along with at least one electrical power supply socket Pr.

The application management device 20b is a device that is capable, for example, of controlling the turning on, the temperature variation, the turning off of an oven Fr.

The application management device 20c is a device that is capable, for example, of controlling the operation, of turning off a robot vacuum cleaner Ra.

Of course, the present invention is not limited to the aforementioned examples and is applicable to other applications.

It is to be noted herein that the voice command analyzer-distributor device 10 can be placed outside the building or even in a server managing the analysis and distribution of voice commands for a plurality of buildings.

In this case, only a sensor and an interface for communications outside the building will be placed inside the building.

FIG. 2 shows an example of an architecture of a voice command analyzer-distributor device according to the present invention.

The voice command analyzer-distributor device 10 comprises:

a processor, microprocessor or microcontroller 200;

a volatile memory 203;

a non-volatile memory 202;

a voice sensor interface 205;

a communication interface 206 with the application management devices 20;

a communication bus connecting the processor 200 to the ROM memory 202, to the RAM memory 203, to the voice sensor interface 205 and to the communication interface 206 with the application management devices 20.

The processor 200 is capable of executing instructions loaded into the volatile memory 203 from the non-volatile memory 202, from an external memory (not shown), from a storage medium, such as an SD card or other, or from a communication network. When the voice command analyzer-distributor device 10 is powered up, the processor 200 is capable of reading and executing instructions from the volatile memory 203. These instructions form a computer program that causes all or part of the method described with reference to FIG. 4 to be implemented by the processor 200.

All or part of the method described with reference to FIG. 4 can be implemented in software form by executing a set of instructions using a programmable machine, such as a DSP (Digital Signal Processor) or a microcontroller or can be implemented in hardware form by a dedicated machine or component, such as an FPGA (Field-Programmable Gate Array) or an ASIC (Application-Specific Integrated Circuit).

FIG. 3 shows an example of an architecture of an application management device according to the present invention.

The application management device 20 comprises:

a processor, microprocessor or microcontroller 300;

a volatile memory 303;

a non-volatile memory 302;

a communication interface 305 with the voice command analyzer-distributor device 10;

an interface 306 for controlling peripheral units managed by the application management device, such as a radio interface, for example;

a communication bus connecting the processor 300 to the ROM memory 302, to the RAM memory 303, to the communication interface 205 and to the interface for controlling peripheral units managed by the application management device 20.

The processor 300 is capable of executing instructions loaded into the volatile memory 303 from the non-volatile memory 302, from an external memory (not shown), from a storage medium, such as an SD card or other, or from a communication network.

When the application management device 20 is powered up, the processor 300 is capable of reading and executing instructions from the volatile memory 303. These instructions form a computer program that causes all or part of the method described with reference to FIG. 5 to be implemented by the processor 300.

All or part of the method described with reference to FIG. 5 can be implemented in software form by executing a set of instructions using a programmable machine, such as a DSP (Digital Signal Processor) or a microcontroller or can be implemented in hardware form by a dedicated machine or component, such as an FPGA (Field-Programmable Gate Array) or an ASIC (Application-Specific Integrated Circuit).

It is to be noted herein that the voice command analyzer-distributor device 10 and the application management devices 20 can be integrated in the same device and, in this case, can share the same processor.

FIG. 4 shows an example of an algorithm executed by a voice command analyzer-distributor device according to the present invention.

More specifically, the present algorithm is described in an example in which it is executed by the processor 200 of the voice command analyzer-distributor device 10.

In step E400, the processor 200 verifies whether a voice command is received by the voice sensor interface 205.

If so, the processor 200 proceeds to step E401. If not, the processor 200 proceeds to step E406.

In step E401, the processor 200 performs an analysis of the voice command. The processor 200 searches to determine whether words or groups of words included in the voice command belong to a list comprising a set of words and/or groups of words stored in the volatile memory 203. For example, the processor 200 searches the voice command for the words “heating”, “bedroom” or “oven”, “preheating”.

In the next step E402, the processor 200 searches, among the application management devices 20, for an application management device 20 that is capable of processing said analyzed voice command.

To this end, the processor 200 identifies the application management device 20 that is associated with the list comprising a set of words and/or groups of words in which the word or group of words included in the voice command is included.

In the next step E403, the processor 200 verifies whether an application management device 20 is capable of processing said analyzed voice command.

If not, the processor 200 returns to step E400 pending a new voice message. If so, the processor 200 proceeds to step E404.

In step E404, the processor 200 transcribes the voice message into a language or vocabulary that can be interpreted by the application management device 20 identified as being capable of processing said analyzed voice command. The transcription is, for example, the formatting of a text that can be used by the application management device 20 identified as being capable of processing said analyzed voice command or a set of symbols corresponding to the identified word or words.

In the next step E405, the processor 200 controls the transfer of the transcription to the application management device 20 identified as being capable of processing said analyzed voice command.

Once this operation is complete, the process 200 returns to step E400.

In step E406, the processor 200 verifies whether a list comprising a set of words and/or groups of words is received from an application management device 20.

For example, the application management device 20a transfers, during its installation in the building, the list of all the words and/ groups of words that can be interpreted by the application management device 20a.

For example, the list comprising a set of words and/or groups of words comprises the following non-exhaustive list: “open living room roller shutter”, “close living room roller shutter”, “increase living room roller shutter opening”, “open bedroom roller shutter”, “close bedroom roller shutter”, “increase bedroom roller shutter opening”, “increase heating by X degrees”, “lower heating by X degrees”, “increase living room lighting”, “lower living room lighting”, “turn on bedroom lighting”, “turn off bedroom lighting”.

For example, the application management device 20b transfers, during its installation in the building, the list comprising a set of words and/or groups of words that can be interpreted by the application management device 20b.

For example, the list comprising a set of words and/or groups of words comprises the following non-exhaustive list: “turn on”, “oven”, “stop”, “thermostat”.

If a list of words or phrases is received, the processor 200 proceeds to step E407. If not, the processor 200 proceeds to step E408.

In step E407, the processor 200 stores the list of received words and/or groups of words, as well as an identifier of the application management device that transferred the received list of words or phrases.

In a particular embodiment of the present invention, the list further comprises one or more symbols for each word or group of words.

Once this operation is complete, the processor 200 returns to step E400.

In step E408, the processor 200 verifies whether a message is received from an application management device 20. The message comprises a report of the non-execution of a transcribed voice command, as well as a possible list of at least one word and/or at least one group of words associated with the received transcribed voice command. This word or group of words is a command that is not positively recognized by the application manager 20. This word or group of words has been previously received by the application management device 20 and does not correspond to a command for a peripheral unit managed by the application management device 20. This word or group of words may have become obsolete in view of the evolution of the peripheral units managed by the application management device 20 or may be associated with an error in the transcription or the analysis performed by the voice command analyzer-distributor device 10.

If so, the processor 200 proceeds to step E409.

If not, the processor 200 returns to step E400.

In step E409, the processor 200 deletes, from the list comprising a set of words and/or groups of words received from the application management device 20 that transferred the notification, each word or group of words included in the notification.

FIG. 5 shows an example of an algorithm executed by an application management device according to the present invention.

More specifically, the present algorithm is described in an example in which it is executed by the processor 300 of the application management device 20.

In step E500, during the installation of the application management device 20, for example, the processor 300 controls the transfer to the voice command analyzer-distributor device 10 of a list comprising a set of words and/or groups of words that can be interpreted by the application management device 20.

In a particular embodiment of the present invention, the list further comprises one or more symbols for each word or group of words.

For example, the application management device 20a controls the transfer of the following non-exhaustive list: “open living room roller shutter”, “close living room roller shutter”, “increase living room roller shutter opening”, “open bedroom roller shutter”, “close bedroom roller shutter”, “increase bedroom roller shutter opening”, “increase heating by X degrees”, “lower heating by X degrees”, “increase living room lighting”, “lower living room lighting”, “turn on bedroom lighting”, “turn off bedroom lighting”.

For example, the application management device 20b transfers, during its installation in the building, the list comprising a set of words and/or groups of words that can be interpreted by the application management device 20b.

For example, the list comprising a set of words and/or groups of words comprises the following non-exhaustive list: “turn on oven”, “turn off oven”, “oven thermostat X degrees”.

In the next step E501, the processor 300 verifies whether a message comprising a transcribed voice command is received from the voice command analyzer-distributor device 10.

If not, the processor 300 returns to step E501. If so, the processor 300 proceeds to step E502.

In step E502, the processor 300 searches among the peripheral units managed by the application management device 20 for the one or more peripheral units corresponding to the received transcribed voice command.

In step E503, the processor 300 verifies whether at least one peripheral unit managed by the application management device 20 corresponds to the received transcribed voice command.

If not, the processor proceeds to step E505. If so, the processor 300 proceeds to step E504.

In step E504, the processor 300 controls the transfer to the peripheral unit identified in step E502 of a control message that can be interpreted by the peripheral unit.

Once this operation is complete, the processor 300 returns to step E501.

In step E505, the processor 300 stores the transcribed voice command.

In step E506, the processor 300 controls the transfer of a message comprising a report of the non-execution of the received transcribed voice command, as well as a possible list of at least one word and/or at least one group of words associated with the received transcribed voice command if no peripheral unit is identified, or if the transcribed voice command cannot be executed. This at least one word or at least one group of words is a command that is not recognized by the application manager 20. This word or group of words previously has been received by the application management device 20 and does not correspond to a command for a peripheral unit managed by the application management device 20. This word or group of words may have become obsolete in view of the evolution of the peripheral units managed by the application management device 20 or may be associated with an error in the transcription or the semantic analysis performed by the voice command analyzer-distributor device 10.

Once this operation is complete, the processing 300 returns to step E501.

Of course, the present invention is by no means limited to the embodiments described herein, but, on the contrary, it encompasses any variation within the abilities of a person skilled in the art.

1) A method for analyzing and distributing voice commands transmitted by an individual seeking to control a peripheral unit from among a plurality of peripheral units contained in a building, wherein at least one peripheral unit is managed by an application management device different from at least one other application management device managing at least one other peripheral unit, the method causing a device for analyzing and distributing voice commands to perform:
receiving, from each application management device, a list of words and/or groups of words that can be interpreted by the application management device;
storing each list of words and/or groups of words in combination with an identifier of the application management device that transferred the list of words and/or groups of words;
detecting the reception of a voice command;
analyzing the voice command by seeking if a word or group of words included in the voice command and belongs to a list of words or group of words stored in the device for analyzing and distributing voice commands;
identifying the application management device associated with the list comprising a set of words and/or groups of words in which the word or the group of words included in the voice command belongs to;
transcribing the voice command into a vocabulary that can be interpreted by the identified application management device;
transferring the transcribed voice command to the identified application management device.

2) The method as claimed in claim 1, wherein the method further comprises the following steps:
receiving a message comprising at least one word or at least one group of words from an application management device;
deleting the at least one word or the at least one group of words from the list of words or groups of words associated with the identifier of the application management device that transferred the at least one word or the at least one group of words.

3) The method as claimed in claim 1, wherein the transcription of the voice command is in the form of text or of symbols representing words.

4) The method as claimed in claim 1, wherein the method further comprises the following steps executed by each application manager:
receiving a transcribed voice command;
identifying the peripheral unit capable of processing the transcribed voice command;
transferring a peripheral unit control message to the peripheral unit.

5) The method as claimed in claim 4, wherein the method further comprises the following step executed by an application management device if the application management device cannot identify a peripheral unit or process the transcribed voice command:
transferring a message comprising a report of the non-execution of the received transcribed voice command, as well as a possible list of at least one word and/or of at least one group of words associated with the received transcribed voice command.

6) A device for analyzing and distributing voice commands transmitted by an individual seeking to control a peripheral unit from among a plurality of peripheral units contained in the building, wherein at least one peripheral unit is managed by an application management device different from at least one other application management device managing at least one other peripheral unit, the device comprises circuitry causing the device to perform:
receiving, from each application management device, a list of words and/or groups of words that can be interpreted by the application management device;
storing each list of words and/or groups of words in combination with an identifier of the application management device that transferred the list of words and/or groups of words;
detecting the reception of a voice command;
analyzing the voice command by seeking a word or group of words included in the voice command belongs to a list of words or group of words stored in the device for analyzing and distributing voice commands;
identifying the application management device associated with the list comprising a set of words and/or groups of words in which the word or the group of words included in the voice command belongs to;
transcribing the voice command into a vocabulary that can be interpreted by the identified application management device;
transferring the transcribed voice command to the identified application management device.

7) A system comprising a device as claimed in claim 6, wherein the system comprises application managers and in that each application manager comprises circuitry causing the application manager to perform:
receiving a transcribed voice command;
identifying the peripheral unit capable of processing the transcribed voice command;
means for transferring a peripheral unit control message to the peripheral unit.

8) The system as claimed in claim 7, wherein each application manager circuitry causing the application manager to perform:
transferring a message comprising a report of the non-execution of the received transcribed voice command, as well as a possible list of at least one word and/or of at least one group of words associated with the received transcribed voice command if no peripheral unit is identified or if the transcribed voice command cannot be executed.
